(19) United States
(12) Patent Application Publication
(10) Pub. No.: US 2024/0175148 A1
(43) Pub. Date: May 30, 2024

(54) NANO ELECTROCATALYST FOR EFFICIENT PRODUCTION OF HYDROGEN IN AN ELECTROLYZER BY WATER ELECTROLYSIS

(71) Applicant: Hindustan Petroleum Corporation Limited, Bengaluru (IN)

(72) Inventors: Bharati Panigrahy, Bengaluru (IN); Krishnamurthy Narayanan, Bengaluru (IN); Ramachandrarao Bojja, Bengaluru (IN)

(21) Appl. No.: 18/519,118

(22) Filed: Nov. 27, 2023

(30) Foreign Application Priority Data
Nov. 25, 2022 (IN) 202241067992

(51) Int. Cl. C25B 11/061; C25B 1/04; C25B 11/031

(52) U.S. Cl. CPC C25B 11/061; C25B 1/04; C25B 11/031

(57) ABSTRACT

The presently claimed invention relates to a water electrolyzer. More particularly, the presently claimed invention relates to an electrocatalyst for use as an electrode in the water electrolyzer.

### CROSS-REFERENCE TO RELATED APPLICATIONS

The present application claims priority from Indian Patent Application No. 202241067992 filed on Nov. 25, 2022. The contents of all of the aforementioned applications are incorporated by reference herein in their entirety.

### TECHNICAL FIELD

The presently claimed invention relates to a water electrolyzer. More particularly, the presently claimed invention relates to an electrocatalyst for use as an electrode in the water electrolyzer.

### BACKGROUND

Background description includes information that may be useful in understanding the present invention. It is not an admission that any of the information provided herein is prior art or relevant to the presently claimed invention, or that any publication specifically or implicitly referenced is prior art.

Hydrogen, as a clean and renewable energy resource, has been intensely investigated as an alternative to the diminishing fossil fuel. An effective way of producing high purity hydrogen is to electrochemically split water into hydrogen and oxygen in an electrolyzer. To this effect, alkaline water electrolysis is being used to generate clean energy in the form of hydrogen using platinum group metals, particularly platinum and iridium, as electrocatalysts. However, due to the scarcity and cost of these platinum group metals, the economic viability for large scale electrolysis application is very minimum or nil.

To address the challenges existing with the platinum group metals, there has been a growing demand towards using active and stable non-precious, metal based electrocatalysts comprising Raney nickel and nickel-molybdenum alloy. While these metals seem to be a feasible alternative to platinum group metals in terms of their availability and cost, achieving high activity and stability has always been a challenge. Some of the documents related to existing electrocatalysts and/or electrolyzers are summarized hereinbelow.

WO 2016/011342A discloses an electrode for water splitting production. The electrode comprises a porous substrate and an electrocatalyst affixed to the porous substrate. The electrocatalyst includes heterostructures of several metals, for e.g., nickel and chromium.

EP 3575442 B1 discloses a bipolar electrolyzer for alkaline water electrolysis. The electrolyzer comprises anodes and cathodes, wherein at least one of the anode or cathode is a porous electrode. The porous electrode comprises a substrate and a catalyst layer, such as nickel, formed on a surface of the substrate.

There is an abundance of not only patent but non-patent documents in the field of electrocatalyst. For instance, Zhao et. al., An earth-abundant and multifunctional Ni nanosheets array as electrocatalysts and heat absorption layer integrated thermoelectric device for overall water splitting, Nano Energy 56 (2019), 563-570, discloses a two-electrode configuration employing Ni nanosheets array on hot end of the thermoelectric (TE) device whereas integrated NiFe hydroxide film on carbon cloth on the cold end of the TE as cathode. Another research by Guo et. al., Self-supported tremella like MoS₂-AB particles on nickel foam as bifunctional electrocatalyst for overall water splitting, Nano Energy, vol. 92 (2022), ISSN 2211-2855, discloses tremella-like MoS₂-AB particles on nickel foam substrate fabricated through a one-step solvothermal reaction. Overpotentials of 77 mV and 248 mV have been reported for catalytic current density of 10 mA·cm² for hydrogen evolution reaction and oxygen evolution reaction, respectively.

To summarize, the existing solutions are either based on materials from the platinum group metals, or necessarily require surface modification of a porous substrate for use in an electrolyzer. Where the catalytic effect of the electrocatalyst is good, the cost savings in the process can warrant their use, but in case of platinum group metals, the cost of the electrocatalyst is prohibitive. The surface modification primarily includes affixing organic and/or inorganic nanostructures onto the surface of the porous substrate. Surface modification of porous substrate although results in improved performance properties, the complex process required for modification results in the electrode material being expensive. Further, most of the studies in the state of the art have not reported testing using an electrolyzer. The experimentation has been carried out using one or more beakers. Since the beaker system is capable of resembling the electrolysis conditions in general, an understanding of the practical limitations in an electrolyzer system or assembly is not possible and therefore, a lot of these electrocatalysts result in inferior properties when employed in actual electrolyzers.

It is, therefore, an object of the present invention to provide an electrode material for a water electrolyzer effective in mitigating one or more of the challenges in the state of the art.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

### SUMMARY

The presently claimed invention relates to a water electrolyzer. More particularly, the presently claimed invention relates to an electrocatalyst for use as an electrode in the water electrolyzer.

Surprisingly, it has been found that the above object is met by providing an electrode material consisting of an acid etched porous substrate, which is devoid of any surface modifications.

Accordingly, in one aspect, the present invention relates to a water electrolyzer comprising an anode, a cathode, and a power supply electrically connected to the anode and the cathode. At least one of the anode and cathode consists of an acid etched porous substrate, which is devoid of any surface modifications.

In an embodiment, the acid etched porous substrate is obtained by acid etching the porous substrate in a mineral acid for a duration ranging between 0.1 h to 2 h under sonication at a temperature ranging between 20° C. to 80° C.

In another embodiment, the surface modification includes organic nanostructures and/or inorganic nanostructures.

In yet another embodiment, the porous substrate is selected from the group consisting of: nickel foam, copper foam, carbon foam, graphite foam, carbon fiber paper, carbon nanotube network, graphene foam, titanium foam, and aluminum foam. In some embodiments, the porous substrate is nickel foam.

In still another embodiment, the acid in the acid etching is a mineral acid. The mineral acid is selected from hydrochloric acid, sulfuric acid, nitric acid, phosphoric acid, hydrofluoric acid, hydrobromic acid and hydroiodic acid. In an embodiment, the mineral acid is sulfuric acid.

In a further embodiment, the electrolyzer is a single cell electrolyzer.

In another aspect, the present invention relates to a method for water electrolysis in an electrolyzer. The method comprises the step of obtaining at least one of an anode and a cathode. The anode and/or cathode consists of an acid etched porous substrate which is devoid of any surface modifications. The acid etched porous substrate is obtained by acid etching by soaking the porous substrate in a mineral acid for a duration ranging between 0.1 h to 2 h under sonication at a temperature ranging between 20° C. to 80° C.

In still another aspect, the present invention relates to an electrocatalyst consisting of an acid etched porous substrate, which is devoid of any surface modifications. The acid etched porous substrate is obtained by acid etching by soaking the porous substrate in a mineral acid for a duration ranging between 0.1 h to 2 h under sonication at a temperature ranging between 20° C. to 80° C. The electrocatalyst being used as at least one of an anode and a cathode in a water electrolyzer.

Further aspect of the present disclosure relates to use of an electrocatalyst consisting of an acid etched porous substrate, said acid etched porous substrate being devoid of any surface modifications, as at least one of an anode and a cathode in a water electrolyzer.

Various objects, features, aspects and advantages of the inventive subject matter will become more apparent from the following detailed description of preferred embodiments.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIGS. 1a and 1b illustrate exemplary Scanning Electron Microscope (SEM) images of bare Ni foam, and acid etched Ni foam, respectively, in accordance with an embodiment of the present invention.

FIGS. 2a and 2b illustrate exemplary low magnification SEM images of bare Ni foam, and acid etched Ni foam, respectively, in accordance with an embodiment of the present invention.

FIG. 3 illustrate exemplary Powder X-ray diffraction (XRD) images of bare Ni foam and acid etched Ni foam in accordance with an embodiment of the present invention.

FIGS. 4a and 4b illustrate exemplary X-ray photoelectron spectroscopy (XPS) spectra of bare Ni foam and acid etched Ni foam with (a) Ni 3p spectra comparison, and (b) O in bare and acid etched Ni foam comparison, respectively.

FIG. 5 illustrate exemplary Fourier Transform Infrared Spectroscopy (FTIR) spectrum of bare Ni foam and acid etched Ni foam in accordance with an embodiment of the present invention.

FIGS. 6a and 6b illustrate exemplary chronoamperometry analysis of (a) acid etched foam in a prototype single cell electrolyzer and (b) in a beaker set-up in accordance with an embodiment of the present invention.

FIGS. 7a and 7b illustrate exemplary chronoamperometry analysis of (a) acid etched foam in a prototype single cell electrolyzer and (b) bare Ni foam in a prototype single cell electrolyzer in accordance with an embodiment of the present invention.

FIGS. 8a and 8b illustrate exemplary chronoamperometry analysis of (a) acid etched foam in a prototype single cell electrolyzer and (b) surface modified Ni foam in a prototype single cell electrolyzer in accordance with an embodiment of the present invention.

### DETAILED DESCRIPTION

The following is a detailed description of embodiments of the present invention. The embodiments are in such detail as to clearly communicate the invention. However, the amount of detail offered is not intended to limit the anticipated variations of embodiments; on the contrary, the intention is to cover all modifications, equivalents, and alternatives falling within the spirit and scope of the present invention as defined by the appended claims.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability.

Unless the context requires otherwise, throughout the specification which follow, the word “comprise” and variations thereof, such as, “comprises” and “comprising” are to be construed in an open, inclusive sense that is as “including, but not limited to.” It is to be appreciated that the terms “comprising”, “comprises” and “comprised of” as used herein includes the terms “consisting of”, “consists” and “consists of” within their meaning.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

In some embodiments, the numbers expressing quantities of ingredients, properties such as concentration, and so forth, used to describe and claim certain embodiments of the invention are to be understood as being modified in some instances by the term “about.” Accordingly, in some embodiments, the numerical parameters set forth in the written description are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable.

The recitation of ranges of values herein is merely intended to serve as a shorthand method of referring individually to each separate value falling within the range. Unless otherwise indicated herein, each individual value is incorporated into the specification as if it were individually recited herein.

The headings and abstract of the invention provided herein are for convenience only and do not interpret the scope or meaning of the embodiments.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

Various terms as used herein are shown below. To the extent a term used in a claim is not defined below, it should be given the broadest definition persons in the pertinent art have given that term as reflected in printed publications and issued patents at the time of filing.

The presently claimed invention relates to a water electrolyzer. More particularly, the presently claimed invention relates to an electrocatalyst for use as an electrode in the water electrolyzer.

An aspect of the present invention is directed towards a water electrolyzer.

In an embodiment, the water electrolyzer comprises an anode, a cathode, and a power supply electrically connected to the anode and the cathode. In another embodiment, at least one of the anode and the cathode consists of an acid etched porous substrate, which is devoid of any surface modifications.

The anode is configured to promote water oxidation or oxygen evolution reaction (OER), whereas the cathode is configured to promote water reduction or hydrogen evolution reaction (HER). A suitable electrolyte is also disposed between, and in contact with the anode and the cathode. The electrolyte is an aqueous electrolyte and can be alkaline, acidic or neutral. The power supply electrically connects to the anode and the cathode and is configured to supply electricity to promote OER and HER at the anode and cathode, respectively. The power supply can include, such as but not limited to, a primary or secondary battery or a solar cell.

Additional components privy to an electrolyzer may also be included in the present invention. For instance, a selectively permeable membrane or other partitioning component can be included to partition the anode and the cathode into respective components.

In the present context, “surface modification” refers to modification of the porous substrate with any organic nanostructures and inorganic nanostructures in any form, such as but not limited to, particles, layers, and the likes. During surface modification, these organic nanostructures and inorganic nanostructures are affixed to the surface of the porous substrates using chemical and/or mechanical techniques, known to the person skilled in the art.

Surprisingly, it has been observed that despite of absence of any surface modification, the electrocatalyst or electrode of the present disclosure comprising acid etched porous substrate exhibits improved and/or acceptable electrochemical properties.

It may be noted here that the present invention specifically requires the absence of any additional or external introduction of organic nanostructures and inorganic nanostructures onto the porous substrate. However, any formation of homo-structures (such as hydroxyl ions) on the surface of the acid etched porous substrate as a result of acid etching shall be considered part of the presently claimed invention.

Further, the term “electrocatalyst” is defined as a catalyst that participates in an electrochemical reaction. The electrocatalyst, as described herein, can also be used as an electrode in the electrolyzer.

In an embodiment, the acid etched porous substrate is obtained by acid etching by soaking a porous substrate in a mineral acid for a duration ranging between 0.1 h to 2 h under sonication at a temperature ranging between 20° C. to 80° C. Suitable mineral acid for this purpose are selected from hydrochloric acid, sulfuric acid, nitric acid, phosphoric acid, hydrofluoric acid, hydrobromic acid and hydroiodic acid. In an embodiment, the mineral acid is sulfuric acid.

In an embodiment, the mineral acid in acid etching is an aqueous acid solution.

In another embodiment, sonication is carried out at temperature ranging between 20° C. to 60° C.

The acid etching technique activates the porous substrate. During activation/acid etching the inert surface of the porous substrate reacts with the aqueous acid solution where the hydroxyl ion formation on the porous substrate takes place. As the reaction severity or time increases, concentration of hydroxyl ions on the surface of the porous substrate become more and more, thereby resulting information of hydroxide species of the material used as porous substrate.

In another embodiment, the porous substrate is selected from the group consisting of nickel foam, copper foam, carbon foam, graphite foam, carbon fiber paper, carbon nanotube network, graphene foam, titanium foam, and aluminum foam. In another embodiment, the porous substrate is selected from the group consisting of nickel foam, copper foam, carbon foam, and graphite foam. In still another embodiment, the porous substrate is nickel foam.

Another aspect of the present invention is directed towards a method for water electrolysis in an electrolyzer.

In an embodiment, the method comprises the step of obtaining at least one of an anode and a cathode. The anode and/or cathode consist of an acid etched porous substrate, which is devoid of any surface modifications. In this regard, the embodiments described hereinabove in respect of the electrolyzer are applicable here as well.

In another embodiment, the acid etched porous substrate is obtained by acid etching by soaking the porous substrate in a mineral acid for a duration ranging between 0.1 h to 2 h under sonication at a temperature ranging between 20° C. to 80° C. Suitable mineral acid for this purpose are selected from hydrochloric acid, sulfuric acid, nitric acid, phosphoric acid, hydrofluoric acid, hydrobromic acid and hydroiodic acid. In an embodiment, the mineral acid is sulfuric acid.

In an embodiment, the mineral acid in acid etching is an aqueous acid solution.

In another embodiment, sonication is carried out at temperature ranging between 20° C. to 60° C.

In still another embodiment, the acid etched porous substrate is further subjected to water washing using deionized water followed by washing with acetone and alcohol such as ethanol. pH of the solution is maintained neutral followed by drying of the porous substrate, for further use as electrocatalyst or electrode in the electrolyzer.

Yet another aspect of the present invention is directed towards the use of an electrocatalyst consisting of an acid etched porous substrate as at least one of an anode and a cathode in a water electrolyzer.

In an embodiment, the acid etched porous substrate is devoid of any surface modifications. In this regard, the embodiments described hereinabove in respect of the electrolyzer are applicable here as well.

In another embodiment, the acid etched porous substrate is obtained by acid etching by soaking the porous substrate in a mineral acid for a duration ranging between 0.1 h to 2 h under sonication at a temperature ranging between 20° C. to 80° C. Suitable mineral acid for this purpose are selected from hydrochloric acid, sulfuric acid, nitric acid, phosphoric acid, hydrofluoric acid, hydrobromic acid and hydroiodic acid. In an embodiment, the mineral acid is sulfuric acid.

In still another embodiment, the mineral acid in acid etching is an aqueous acid solution.

In yet another embodiment, sonication is carried out at temperature ranging between 20° C. to 60° C.

While the foregoing description discloses various embodiments of the disclosure, other and further embodiments of the invention may be devised without departing from the basic scope of the disclosure. The invention is not limited to the described embodiments, versions or examples, which are included to enable a person having ordinary skill in the art to make and use the invention when combined with information and knowledge available to the person having ordinary skill in the art.

### EXAMPLES

The presently claimed invention is illustrated by the non-restrictive examples which are as follows:

Sulfuric acid obtained from Sigma Aldrich, India was used as mineral acid, and Nickel foam obtained from MTI Corporation, USA was used as porous substrate in the experiments.

### General Synthesis of Electrocatalyst

Nickel foam pieces of size 5 cm² were soaked in 0.75 M sulfuric acid water solution for 30 to 60 min. Subsequently, the foam was sonicated at temperature of about 45° C. After removal from the acidic solution, the nickel foam pieces were washed several times using deionized water, followed by washing with acetone and ethanol separately. pH of the solution was checked and subsequently washed with deionized water to attain neutral pH. The foam pieces were then dried at 60° C. for overnight and electrocatalysts were obtained for use in water electrolyzer.

Chronoamperometry analysis: In chronoamperometry analysis, polarization curve of the electrolyzer was recorded at an applied voltage of 2 volts for different time period to study the stability of the electrode.

### Testing and Comparative Studies

In order to understand the effect of acid etching on the porous substrate, a comparative sample (using nickel foam) was prepared which was not subjected to acid etching (referred to as “bare Ni foam”).

Morphology of the samples—both bare Ni foam and acid etched Ni foam at two different time period, was investigated using scanning electron microscopy (SEM), combined with energy dispersive X-ray spectroscopy (EDAX) for elemental analysis. Powder X-ray diffraction (XRD) and X-ray photoelectron spectroscopy (XPS) studies were conducted to understand the structural differences in the bare Ni foam vs acid etched Ni foam. Infrared spectra were recorded for both the samples to study the functional groups present therein/thereon.

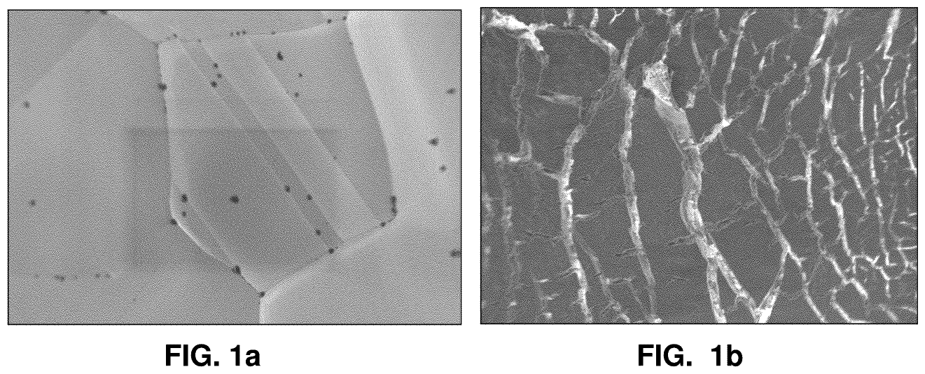

During activation by acid etching, the inert surface of Ni foam reacts with the acid water solution, resulting in the formation of hydroxyl ions on the Ni foam. As the reaction severity or time increases, concentration of hydroxyl ions on Ni foam surface becomes more and more, thereby resulting in formation of Ni hydroxide species on the porous substrate. It was observed that the density of hydroxyl ions on the Ni foam surface varied due to variation of activation (varied between 0.5 h to 2 h). FIGS. 1a and 1b show SEM images of the bare Ni foam and the acid etched Ni foam, respectively. As evident, the Ni hydroxyl species have grown densely on the surface of acid etched Ni foam. On the contrary, the Ni foam surface has become rough with increase in surface area, as shown in FIG. 1a.

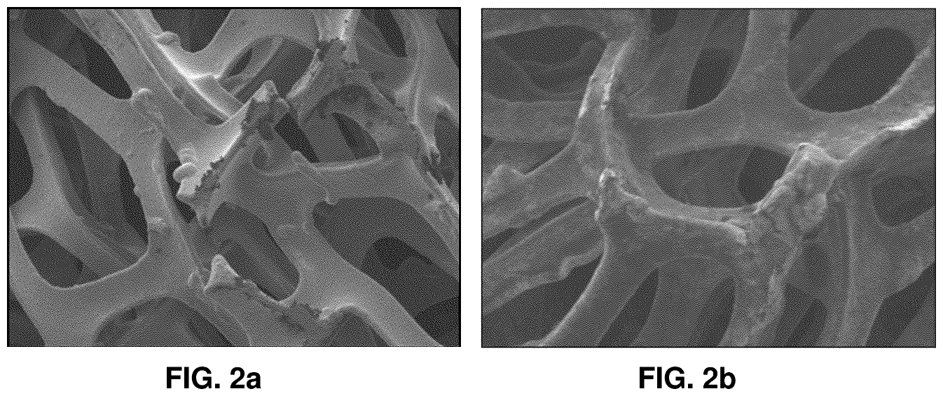

The low magnification SEM images of bare Ni foam and acid etched Ni foam, as shown in FIGS. 2a and 2b, prove that the bare Ni foam has 3D skeleton with smooth surface whereas after activation of Ni foam, the surface has become rough. In fact, porosity of the acid etched Ni foam has increased, thereby resulting in an increased surface area as compared to bare Ni foam.

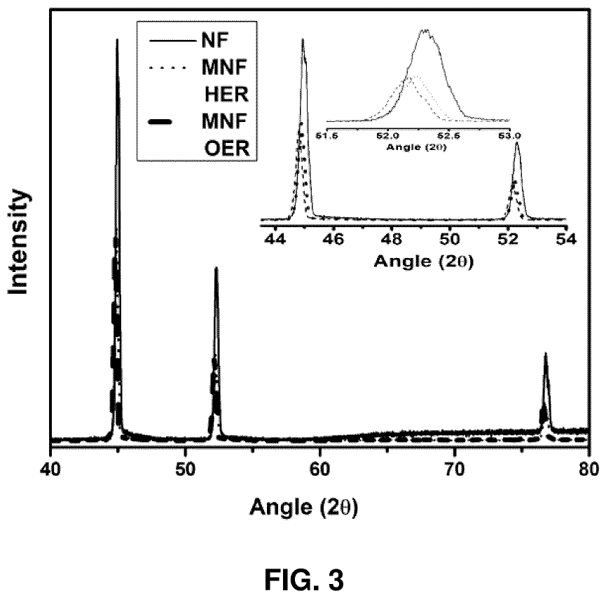

Referring to FIG. 3, crystalline phases of bare Ni foam and acid etched Ni foam were analyzed using XRD. The bare Ni foam (represented by the code “NF” in the drawings) and the acid etched Ni foam (represented by the code “MNF HER”, which denotes Modified Ni Foam in Hydrogen evolution reaction, and “MNF OER”, which denotes Modified Ni Foam in Oxygen evolution reaction, in the drawings) have similar peaks centered at 2θ-values of 44.96°, 52.3°, and 76.8° which can be indexed to the (110), (200), (220) planes of Ni metal derived from Ni foam. As can be seen from the inset in FIG. 3, a zoomed image of the (200) peak centered around 2θ-value of 52.3 was obtained, and it was observed that there was a shift in the XRD peak position towards lower angle as the activation proceeds. It could be noted that for acid etched/modified Ni Foam in Hydrogen evolution reaction (HER) exhibits characteristic peaks centered at 2θ-values of 44.89, 52.24 and 76.72; and acid etched/modified Ni Foam in Oxygen evolution reaction (OER) exhibits characteristic peaks centered at 2θ-values of 44.82, 52.17, and 76.66. This confirms that the ionic radius of Ni—Ni atom increased because of the formation of the hydroxyl ion in comparison to the bare Ni foam. Further, as the activation time increases, a decrease in the ionic radii of the electrodes containing acid etched Ni foam of the present invention was observed.

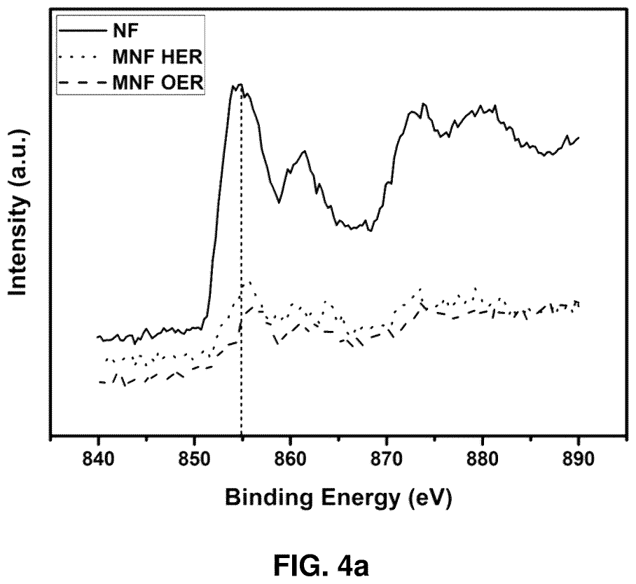

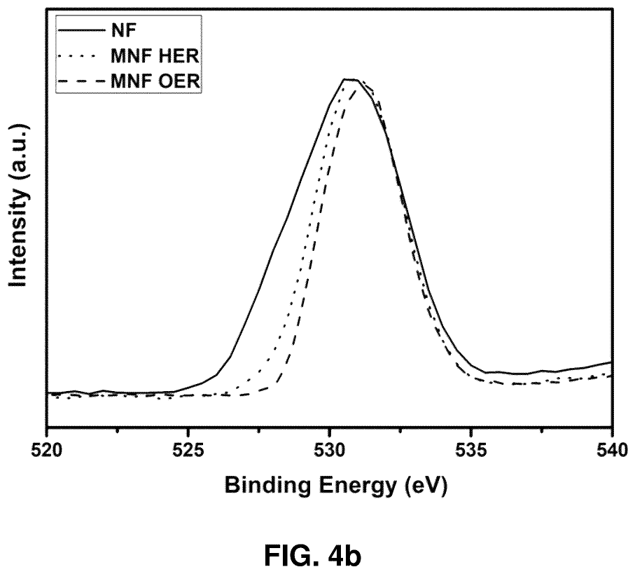

Referring to FIGS. 4a and 4b, the chemical binding state and elemental composition of bare Ni foam and acid etched Ni Foam was investigated. The survey XPS spectrum of Ni foam contains Ni and O elements. FIGS. 4a and 4b show high resolution Ni 2p spectra and O 1s spectra, respectively for bare Ni foam and acid etched Ni foam. From FIG. 4b, it can be observed that the activated Ni foam peak intensity is maximum at high binding energy compared to the bare Ni foam, thereby confirming that the metal hydroxide concentration is more in the activated/acid etched Ni foam compared to the bare Ni foam.

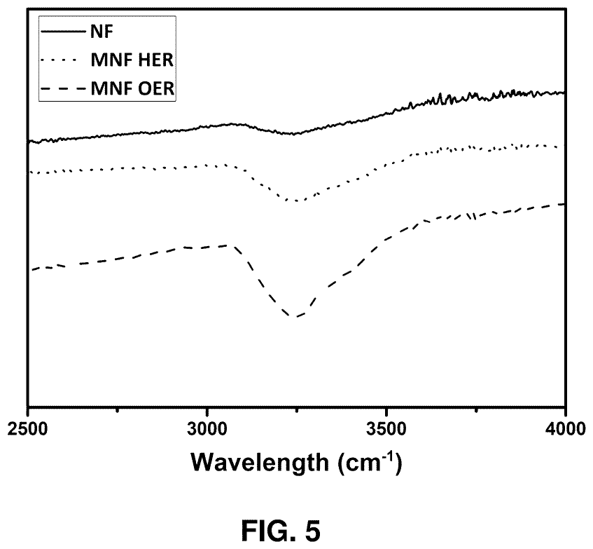

Referring to FIG. 5, it can be observed that the intensity of Ni peak decreases as the activation of the Ni foam happens. As this is a surface characterization technique, and hydroxyl ions are embedded on the surface of the Ni foam after activation, XPS spectra for Ni 2p reveals very low intense Ni oxidation peaks. The peaks at binding energy of 873.6 eV and 854.7 eV may be assigned to Ni2p1/2 and Ni2p3/2 of NiO, respectively. For etched Ni foam, peak position for Ni2p1/2 and Ni2p3/2 shifts towards high binding energy which confirms transfer of electrons from Ni to the active hydroxyl ion species, which will eventually take part in the water splitting reaction for oxidation followed by reduction to generate oxygen and hydrogen, respectively. As the activation time increases, the shift towards higher binding energy is more, thereby confirming that the electron density on the Ni species has decreased. The O 1s spectra appeared at 530.4 eV in bare Ni foam, whereas in etched Ni foam the peak value was obtained at 531.1 eV. The low binding energy peak is attributed to the typical band of oxygen in metal oxides (M—O), whereas the higher binding energy peak corresponds to hydroxides (M—OH).

Further referring to FIG. 5, in bare Ni foam O—H stretching frequency was observed around 3241 cm⁻¹ which in case of etched Ni foam was around 3250 cm⁻¹. This implies that mass of the molecule was reduced as stretching frequency is inversely proportional to mass. It can also be concluded that bond length has decreased, which resulted in an increase in the strength and hence, the shift is observed to the higher side. FIG. 5 also shows that there is a significant increase in the intensity of the peak corresponding to O—H stretching frequency for the activated Ni foam, thereby confirming an increase in the concentration of hydroxyl ions post activation.

### Electrolyzer and Beaker Studies

A beaker set-up wherein anode and cathode electrodes were immersed in a beaker containing the same electrolyte concentration as in electrolyzer set-up (5-30 wt. %) was used for comparison purpose. Direct charge transfer in the beaker takes place without any membrane.

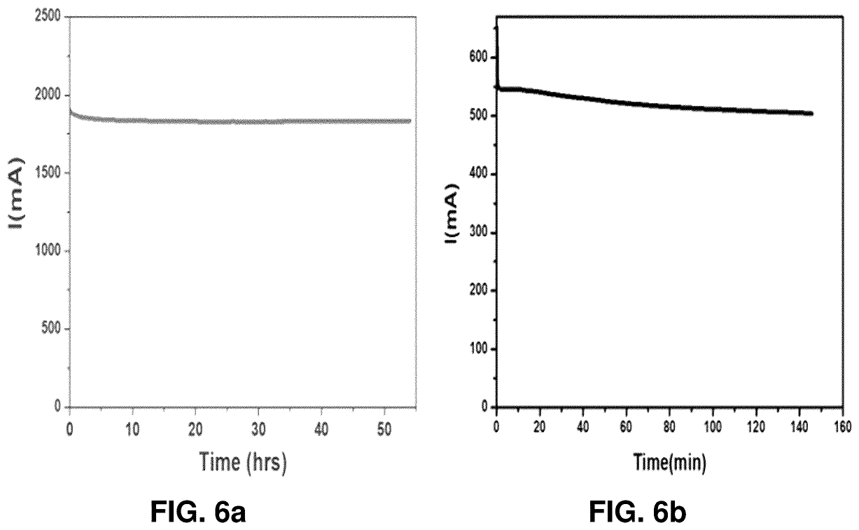

Water splitting reaction evaluation to generate hydrogen and oxygen was carried out in a prototype single cell electrolyzer and compared with the beaker set-up. Referring to FIGS. 6a and 6b, it can be observed that the kinetics of water splitting is significantly higher in prototype electrolyzer compared to the two-electrode experimentation and evaluation in the beaker set-up.

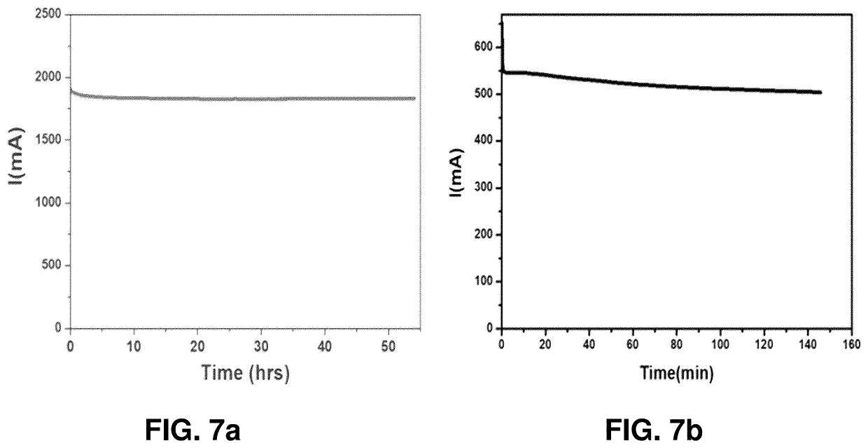

Additionally, water splitting kinetics of bare Ni foam and activated Ni foam was studied separately in the same prototype single cell electrolyzer. Referring to FIGS. 7a and 7b, it can be observed that the activated Ni foam shows substantially improved activity compared to the bare Ni foam because of the presence of abundant active sites created during the acid treatment.

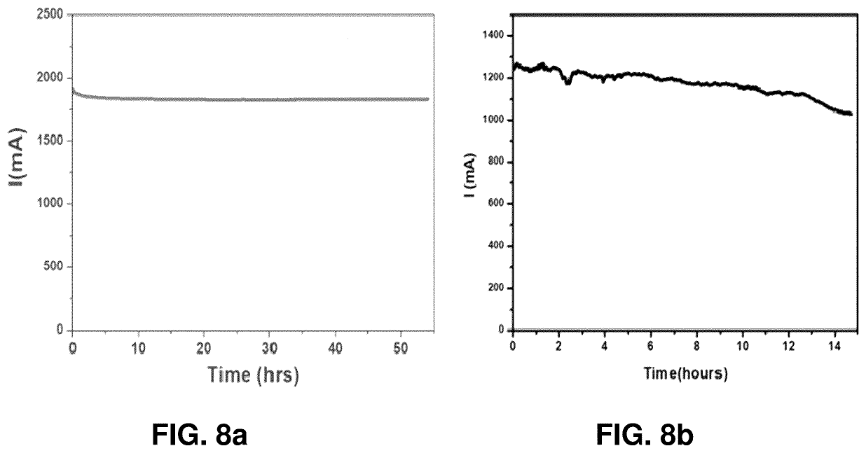

A further study was conducted to study the water splitting kinetics of activated Ni foam with surface modified Ni foam (Ni nanoparticles deposited on Ni foam electrode by wet chemical method). In the wet chemical method, nickel chloride salt was dissolved in 30 ml of ethylene glycol. After dissolution, sodium hydroxide salt and hydrazine monohydrate were added. In order to use the evolving N₂ gas as a protective atmosphere, the system was closed on top. The solution was heated at 60° C. for 4 h with continuous stirring followed by centrifugation to obtain the surface modified Ni foam. Referring to FIGS. 8a and 8b, it can be observed that the activity of the acid etched Ni foam exceeded substantially compared to the surface modified Ni foam.

From the foregoing, it can be concluded that the unmodified acid etched porous substrate of the present invention is highly scalable and inexpensive, thereby resulting in a very cost-effective water electrolyzer. The electrochemical properties showcase substantial improvement over bare Ni foam as well as surface modified Ni foam. Further, the electrocatalyst is highly active and stable with little or no reduction in catalytic activity of the electrocatalyst over several days or weeks. Furthermore, the fabrication technique for obtaining the electrocatalyst requires minimal processing condition, thereby rendering it easy-to-use and scalable at industrial level.

### Advantages

The present disclosure provides a highly scalable and inexpensive electrocatalyst, thereby resulting in a very cost-effective water electrolyzer.

The present disclosure provides an electrocatalyst having improved or acceptable electrochemical properties as well as stability in comparison to electrocatalysts obtained by surface modification of porous substrate and/or containing platinum group metals.

The present disclosure provides an electrocatalyst that is ultra-active and stable with little no reduction in catalytic activity thereof over several days or weeks

The present disclosure provides facile fabrication of electrocatalyst with minimal processing conditions.

We claim:

1. A water electrolyzer comprising:
an anode;
a cathode; and
a power supply electrically connected to the anode and the cathode, wherein at least one of the anode and cathode consists of an acid etched porous substrate, said acid etched porous substrate being devoid of any surface modifications.

2. The electrolyzer as claimed in claim 1, wherein the acid etched porous substrate is obtained by acid etching by soaking a porous substrate in an acid for a duration ranging between 0.1 h to 2 h under sonication at a temperature ranging between 20° C. to 80° C.

3. The electrolyzer as claimed in claim 1, wherein the surface modification comprises organic nanostructures and/or inorganic nanostructures.

4. The electrolyzer as claimed in claim 1, wherein the porous substrate is selected from the group consisting of: nickel foam, copper foam, carbon foam, graphite foam, carbon fiber paper, carbon nanotube network, graphene foam, titanium foam, and aluminum foam.

5. The electrolyzer as claimed in claim 1, wherein the porous substrate is nickel foam.

6. The electrolyzer as claimed in claim 2, wherein the acid in the acid etching is a mineral acid.

7. The electrolyzer as claimed in claim 6, wherein the mineral acid is selected from hydrochloric acid, sulfuric acid, nitric acid, phosphoric acid, hydrofluoric acid, hydrobromic acid and hydroiodic acid.

8. The electrolyzer as claimed in claim 6, wherein the mineral acid is sulfuric acid.

9. The electrolyzer as claimed in claim 1, wherein the electrolyzer is a single cell electrolyzer.

10. A method for water electrolysis in an electrolyzer, said method comprising the step of obtaining at least one of an anode and a cathode, the anode and/or cathode consists of an acid etched porous substrate, which is devoid of any surface modification, said acid etched porous substrate obtained by acid etching by soaking the porous substrate in a mineral acid for a duration ranging between 0.1 h to 2 h under sonication at a temperature ranging between 20° C. to 80° C.

11. Use of an electrocatalyst consisting of an acid etched porous substrate, said acid etched porous substrate being devoid of any surface modifications, as at least one of an anode and a cathode in a water electrolyzer.
